(19) United States
(12) Patent Application Publication
(10) Pub. No.: US 2026/0057583 A1
(43) Pub. Date: Feb. 26, 2026

(54) Visual Prompt Tuning for Generative Transfer Learning

(71) Applicant: Google LLC, Mountain View, CA (US)

(72) Inventors: Kihyuk Sohn, Sunnyvale, CA (US); Lu Jiang, Mountain View, CA (US); Huiwen Chang, New York, NY (US); Yuan Hao, Palo Alto, CA (US); Luisa Polania, Atlanta, GA (US); José Lezama, Atlanta, GA (US); Han Zhang, Sunnyvale, CA (US); Irfan Essa, Atlanta, GA (US)

(21) Appl. No.: 19/106,308

(22) PCT Filed: Dec. 15, 2022
(86) PCT No.: PCT/US2022/053015

§ 371 Date: Feb. 25, 2025

Related U.S. Application Data
(60) Provisional application No. 63/406,841, filed on Sep. 15, 2022.

(51) Int. Cl. G06T 11/60

(52) U.S. Cl. CPC G06T 11/60

(57) ABSTRACT

Systems and methods for training and using a prompt token generator to generate a set of prompt tokens which, when fed into a pretrained generative image transformer (e.g., an autoregressive transformer, continuous diffusion model, non-autoregressive transformer, or discrete diffusion model), may bias the generative image transformer's output towards a particular domain (e.g., towards a particular class of images, towards a particular training instance, etc.). In some examples, the prompt token generator may be used to generate a set of different prompt token sequences, which may then be fed sequentially to a pretrained non-autoregressive generative image transformer as it iteratively generates each image in each time-step in order to introduce more diversity into the transformer's final output.

### CROSS-REFERENCE TO RELATED APPLICATIONS

This application claims the benefit of the filing date of U.S. Provisional Application No. 63/406,841, filed Sep. 15, 2022, the entire disclosure of which is hereby incorporated by reference herein.

### BACKGROUND

There are many different types of generative image models capable of generating varied and semantically meaningful images that appear realistic and lack obvious visual artifacts. Generative adversarial networks (“GANs”) can offer state-of-the-art speed, but with some limitations on the variety and realism of the images they can generate. Likelihood-based models such as autoregressive transformers and continuous diffusion models may provide improved image quality over GANs, but may require hundreds of steps to synthesize an image, thus making them orders of magnitude slower. More recently, developments in non-autoregressive transformers and discrete diffusion models have offered a promising middle ground, enabling image quality comparable to state-of-the-art autoregressive transformers and continuous diffusion models, while doing so up to two orders of magnitude faster than autoregressive transformers and continuous diffusion models. However, as the quality of such models continues to improve across multiple domains, attention is increasingly turning to how such models, once trained, can be efficiently adapted to generate images in new domains.

### SUMMARY

The present technology is related to systems and methods for training and using a prompt token generator to generate a set of prompt tokens which, when fed into a pretrained generative image transformer (e.g., an autoregressive transformer, continuous diffusion model, non-autoregressive transformer, or discrete diffusion model), may bias the generative image transformer's output towards a particular domain (e.g., towards a particular class of images, towards a particular training instance, etc.). In some aspects, the present technology concerns systems and methods for training a prompt token generator using training examples that each include a target token sequence representing a first vector-quantized image and a first set of one or more identifiers (e.g., a class identifier, instance identifier, etc.), at least one identifier of the first set of one or more identifiers relating to a subject of the first vector-quantized image. In such a case, the prompt token generator may generate a first sequence of prompt tokens based at least in part on the first set of one or more identifiers, and a pretrained generative image transformer may generate a first output token sequence based at least in part on the first sequence of prompt tokens. This first output token sequence will represent a second vector-quantized image, and may be generated through any suitable number of time-steps. The processing system may compare the first output token sequence to the target token sequence to generate a loss value for the training example in question, which may then be used (by itself, as a part of an aggregate loss value representing multiple training examples, and/or together with other types of loss values) to modify one or more parameters of the prompt token generator. In addition, this process may be repeated using any suitable optimization routine (e.g., stochastic gradient descent) until the prompt token generator learns to generate prompts that cause the pretrained generative image transformer to generate a first output token sequence that closely approximates (or is identical to) the target token sequence of each training example.

In addition, in some aspects, the present technology concerns systems and methods for using a trained prompt token generator along with a pretrained generative image transformer to generate images that will be biased towards a particular domain on which the token generator was trained. In some examples, following the training just described, the prompt token generator may generate a second sequence of prompt tokens based at least in part on a second set of one or more identifiers (e.g., a class identifier, instance identifier, etc.), and then the pretrained generative image transformer may generate a second output token sequence based at least in part on the second sequence of prompt tokens. This second output token sequence will also represent a second vector-quantized image, and may be generated through any suitable number of steps. In this way, by using a particular class identifier from the training set, the prompt token generator may cue the pretrained generative image transformer to generate a second output token sequence which, when converted to a second vector-quantized image, will appear similar to images in that particular class. Likewise, by using a particular instance identifier, the prompt token generator may cue the pretrained generative image transformer to generate a second output token sequence which, when converted to a second-vector quantized image, will appear similar to the particular training example with that instance identifier. Notably, by using the prompt token generator and training method of the present technology with a pretrained generative image transformer, it may be possible to achieve substantially better and more efficient knowledge transfer than is possible with GANs, and to do so over a wide range of new domains. For example, in some aspects, a prompt token generator trained according to the present technology using only 5 training images per class may enable a pretrained generative image transformer to produce images with substantially lower Frechet Inception Distance (“FID”) scores than would be possible from GAN-based transfer-learning methods using 20 to 100 times more images per class.

Further, in some aspects, the present technology concerns systems and methods for sequentially feeding a set of different prompt token sequences to a pretrained non-autoregressive generative image transformer (e.g., non-autoregressive transformer, or discrete diffusion model) as it iteratively generates each image in each time-step. This process may be used to introduce more diversity into the output of the generative image transformer. For example, by interpolating between a second sequence of prompt tokens for a given instance (e.g., a given picture of a dog) and a third sequence of prompt tokens for the class of that given instance (e.g., dogs), it may be possible to generate a set of prompt token sequences that will cause the pretrained generative image transformer to generate a final output token sequence which, when converted to a final image, appears to be a class-consistent variation on the training example with that instance identifier (e.g., a different dog of that same breed, coloring, face shape, etc.). Likewise, by interpolating between a second sequence of prompt tokens for one instance (e.g., a picture of a golden retriever) and a third sequence of prompt tokens for another instance (e.g., a picture of Swiss mountain dog), it may be possible to generate a set of prompt token sequences that will cause the pretrained generative image transformer to generate a final output token sequence which, when converted to a final image, appears to blend the visual characteristics of those two training examples (e.g., a dog that appears to be a mixed breed of a golden retriever and a Swiss mountain dog).

In one aspect, the disclosure describes a computer-implemented method, comprising: (1) for each given training example of a plurality of training examples, the given training example including a target token sequence representing a first vector-quantized image and a first set of one or more identifiers, at least one identifier of the first set of one or more identifiers relating to a subject of the first vector-quantized image: generating, using a prompt token generator, a first sequence of prompt tokens based at least in part on the first set of one or more identifiers: generating, using a pretrained generative image transformer, a first output token sequence based at least in part on the first sequence of prompt tokens, the first output token sequence representing a second vector-quantized image; and comparing, using one or more processors of a processing system, the first output token sequence to the target token sequence to generate a loss value for the given training example; and (2) modifying, using the one or more processors, one or more parameters of the prompt token generator based at least in part on the loss values generated for the plurality of training examples. In some aspects, the prompt token generator comprises two or more multi-layer perceptrons, and modifying the one or more parameters of the prompt token generator comprises modifying one or more parameters of each of the two or more multi-layer perceptrons. In some aspects, the first set of one or more identifiers of the given training example comprises a class identifier relating to the subject of the first vector-quantized image. In some aspects, the first set of one or more identifiers of the given training example comprises an instance identifier relating to the first vector-quantized image. In some aspects, the method further comprises: generating, using the prompt token generator, a second sequence of prompt tokens based at least in part on a second set of one or more identifiers; and generating, using the pretrained generative image transformer, a second output token sequence based at least in part on the second sequence of prompt tokens, the second output token sequence representing a third vector-quantized image. In some aspects, the method further comprises: generating, using the prompt token generator, a second sequence of prompt tokens based at least in part on a second set of one or more identifiers: generating, using the prompt token generator, a third sequence of prompt tokens based at least in part on a third set of one or more identifiers, the third set of one or more identifiers differing from the second set of one or more identifiers by at least one identifier: generating, using the one or more processors, one or more intermediate sequences of prompt tokens based on the second sequence of prompt tokens and the third sequence of prompt tokens: generating, using the pretrained generative image transformer, a second output token sequence based at least in part on the second sequence of prompt tokens, the second output token sequence representing a third vector-quantized image; and generating, using the pretrained generative image transformer, a third output token sequence based at least in part on the second output token sequence and one of the one or more intermediate sequences of prompt tokens, the third output token sequence representing a fourth vector-quantized image. In some aspects, the method further comprises: generating, using the pretrained generative image transformer, a fourth output token sequence based at least in part on one of the one or more intermediate sequences of prompt tokens, the fourth output token sequence representing a fifth vector-quantized image; and generating, using the pretrained generative image transformer, a fifth output token sequence based at least in part on the fourth output token sequence and the third sequence of prompt tokens, the fifth output token sequence representing a sixth vector-quantized image. In some aspects, the method further comprises generating an output image based on the fifth output token sequence.

In another aspect, the disclosure describes a non-transitory computer program product comprising computer readable instructions that, when executed by a processing system, cause the processing system to perform any of the methods described in the preceding paragraph.

In another aspect, the disclosure describes a processing system comprising: (1) a memory storing a pretrained generative image transformer and a prompt token generator; and (2) one or more processors coupled to the memory and configured to train the prompt token generator according to a training method comprising: (a) for each given training example of a plurality of training examples, the given training example including a target token sequence representing a first vector-quantized image and a first set of one or more identifiers, at least one identifier of the first set of one or more identifiers relating to a subject of the first vector-quantized image: generating, using the prompt token generator, a first sequence of prompt tokens based at least in part on the first set of one or more identifiers: generating, using the pretrained generative image transformer, a first output token sequence based at least in part on the first sequence of prompt tokens, the first output token sequence representing a second vector-quantized image; and comparing the first output token sequence to the target token sequence to generate a loss value for the given training example; and (b) modifying one or more parameters of the prompt token generator based at least in part on the loss values generated for the plurality of training examples. In some aspects, the prompt token generator comprises a multi-laver perceptron. In some aspects, the prompt token generator comprises two or more multi-layer perceptrons. In some aspects, the one or more processors being configured to modify the one or more parameters of the prompt token generator comprises modifying one or more parameters of each of the two or more multi-layer perceptrons. In some aspects, the one or more processors are further configured to: generate, using the prompt token generator, a second sequence of prompt tokens based at least in part on a second set of one or more identifiers; and generate, using the pretrained generative image transformer, a second output token sequence based at least in part on the second sequence of prompt tokens, the second output token sequence representing a third vector-quantized image. In some aspects, the one or more processors are further configured to: generate, using the prompt token generator, a second sequence of prompt tokens based at least in part on a second set of one or more identifiers: generate, using the prompt token generator, a third sequence of prompt tokens based at least in part on a third set of one or more identifiers, the third set of one or more identifiers differing from the second set of one or more identifiers by at least one identifier: generate one or more intermediate sequences of prompt tokens based on the second sequence of prompt tokens and the third sequence of prompt tokens: generate, using the pretrained generative image transformer, a second output token sequence based at least in part on the second sequence of prompt tokens, the second output token sequence representing a third vector-quantized image; and generate, using the pretrained generative image transformer, a third output token sequence based at least in part on the second output token sequence and one of the one or more intermediate sequences of prompt tokens, the third output token sequence representing a fourth vector-quantized image. In some aspects, the one or more processors are further configured to: generate, using the pretrained generative image transformer, a fourth output token sequence based at least in part on one of the one or more intermediate sequences of prompt tokens, the fourth output token sequence representing a fifth vector-quantized image; and generate, using the pretrained generative image transformer, a fifth output token sequence based at least in part on the fourth output token sequence and the third sequence of prompt tokens, the fifth output token sequence representing a sixth vector-quantized image. In some aspects, the one or more processors are further configured to generate an output image based on the fifth output token sequence. In some aspects, the one or more processors are configured to generate the output image using a decoder of the pretrained generative image transformer. In some aspects, the pretrained generative image transformer is an autoregressive image transformer. In some aspects, the pretrained generative image transformer is a non-autoregressive image transformer.

### BRIEF DESCRIPTION OF THE DRAWINGS AND APPENDICES

FIG. 1 is a functional diagram of an example system in accordance with aspects of the disclosure.

FIG. 2 is a functional diagram of an example system in accordance with aspects of the disclosure.

FIG. 3 is a flow chart illustrating an exemplary process flow for generating an image using an autoregressive transformer and a sequence of prompt tokens, in accordance with aspects of the disclosure.

FIG. 4 is a flow chart illustrating an exemplary process flow for generating an image using a non-autoregressive transformer and a sequence of prompt tokens, in accordance with aspects of the disclosure.

FIG. 5 is a flow chart illustrating an exemplary process flow for generating a sequence of prompt tokens using a prompt token generator, in accordance with aspects of the disclosure.

FIG. 6 is a flow chart illustrating an exemplary process flow for generating an output token sequence based on a sequence of prompt tokens using a pretrained generative image transformer, in accordance with aspects of the disclosure.

FIG. 7 is a diagram illustrating exemplary images generated by a pretrained generative image transformer based on a single instance prompt, in accordance with aspects of the disclosure.

FIG. 8 is a diagram illustrating exemplary images generated by a pretrained generative image transformer based on a set of prompts interpolated between a set of prompts for a single instance and a set of prompts for a class, in accordance with aspects of the disclosure.

FIG. 9 is a diagram illustrating exemplary images generated by a pretrained generative image transformer based on a set of prompts interpolated between sets of prompts for two different instances, in accordance with aspects of the disclosure.

FIG. 10 depicts an exemplary method for training a prompt token generator, in accordance with aspects of the disclosure.

FIG. 11 depicts an exemplary method for using a trained prompt token generator to generate a sequence of prompt tokens and using a pretrained generative image transformer to generate an output token sequence based on the sequence of prompt tokens, in accordance with aspects of the disclosure.

FIG. 12A depicts an exemplary method for using a trained prompt token generator to generate two sequences of prompt tokens, generating one or more intermediate sequences of prompt tokens based on the two sequences of prompt tokens generated by the token generator, and sequentially feeding two of the sequences of prompt tokens to a pretrained generative image transformer to generate two successive output token sequences, in accordance with aspects of the disclosure.

FIG. 12B depicts an exemplary method building from the exemplary method of FIG. 12A, for sequentially feeding another two of the generated sequences of prompt tokens to the pretrained generative image transformer to generate two additional successive output token sequences, in accordance with aspects of the disclosure.

### DESCRIPTION

The present technology will now be described with respect to the following exemplary systems and methods. Reference numbers in common between the figures depicted and described below are meant to identify the same features.

### Example Systems

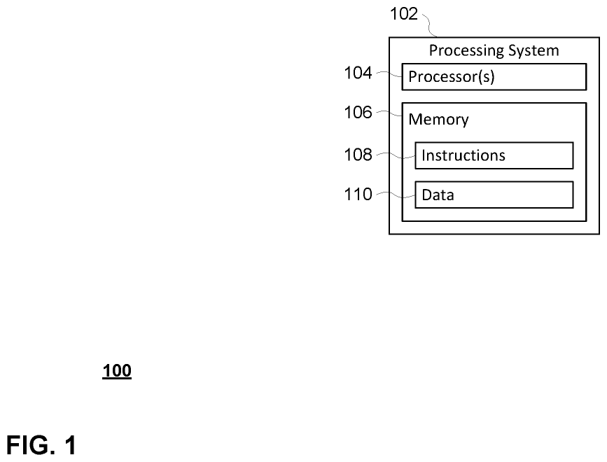

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a pretrained generative image transformer (e.g., an autoregressive transformer, continuous diffusion model, non-autoregressive transformer, or discrete diffusion model) and/or a prompt token generator (e.g., one or more multi-layer perceptrons), as described further below. In addition, the data 110 may store training examples to be used in training the prompt token generator, outputs from the prompt token generator and/or the pretrained generative image transformer produced during training, training signals and/or loss values generated during such training, and/or outputs from the prompt token generator and/or the pretrained generative image transformer generated during inference.

Processing system 102 may be resident on a single computing device. For example, processing system 102 may be a server, personal computer, or mobile device, and a pretrained generative image transformer and/or a prompt token generator may thus be local to that single computing device. Similarly, processing system 102 may be resident on a cloud computing system or other distributed system. In such a case, a pretrained generative image transformer and/or a prompt token generator may be distributed across two or more different physical computing devices. For example, the processing system may comprise a first computing device storing layers 1-n of a pretrained generative image transformer and/or a prompt token generator having m layers, and a second computing device storing layers n-m of the pretrained generative image transformer and/or the prompt token generator. In such cases, the first computing device may be one with less memory and/or processing power (e.g., a personal computer, mobile phone, tablet, etc.) compared to that of the second computing device, or vice versa. Likewise, in some aspects of the technology, the processing system may comprise one or more computing devices storing a pretrained generative image transformer, and one or more separate computing devices storing a prompt token generator. Further, in some aspects of the technology, data used and/or generated during training or inference of a generative image transformer and/or a prompt token generator (e.g., training examples, model outputs, loss values, etc.) may be stored on a different computing device than the generative image transformer and/or the prompt token generator.

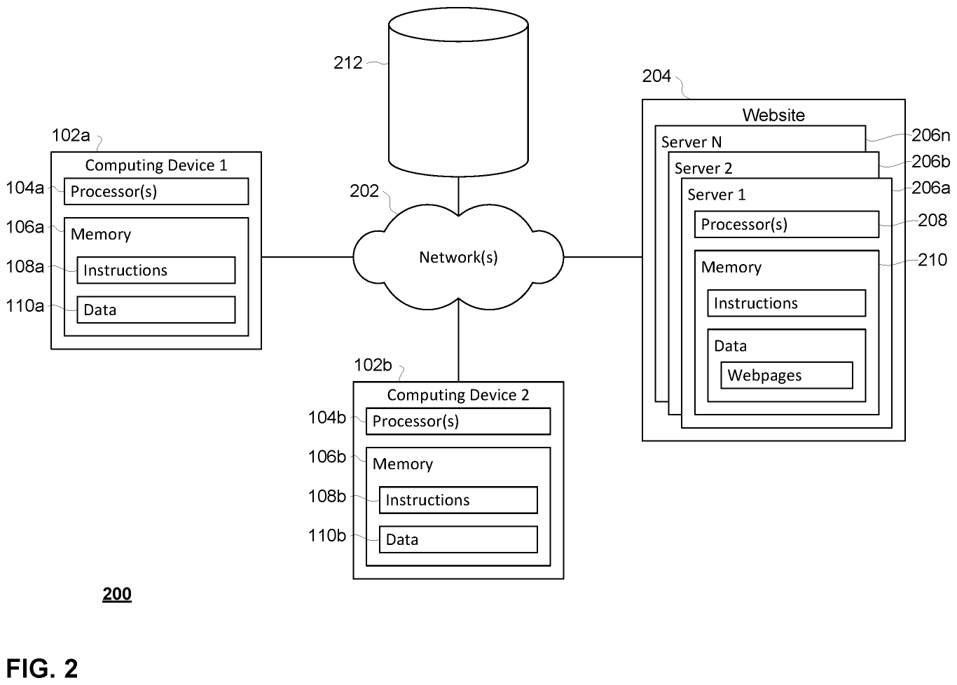

Further in this regard, FIG. 2 shows a high-level system diagram 200 in which the exemplary processing system 102 just described is distributed across two computing devices 102a and 102b, each of which may include one or more processors (104a, 104b) and memory (106a. 106b) storing instructions (108a, 108b) and data (110a. 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use during training of a prompt token generator. For example, in some aspects, the first computing device 102a may be configured to retrieve training images or target token sequences and associated identifiers (e.g., class identifiers, instance identifiers, etc.) from the remote storage system 212. Those training images or target token sequences and associated identifiers may then be fed to a prompt token generator housed on the first computing device 102a to generate prompts which will in turn be fed into a pretrained generative image transformer housed on a second computing device 102b.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C #, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

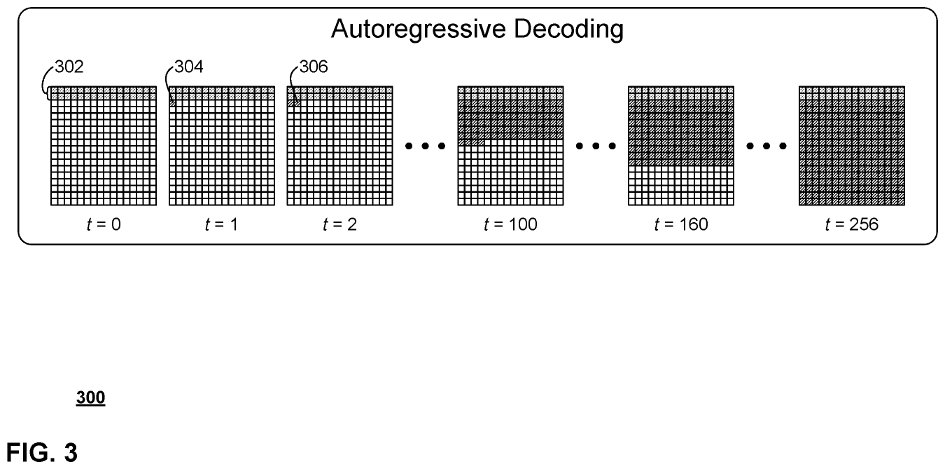

FIG. 3 is a flow chart illustrating an exemplary process flow 300 for generating an image using an autoregressive transformer and a sequence of prompt tokens, in accordance with aspects of the disclosure.

In that regard, FIG. 3 illustrates exemplary outputs representing time-steps t=0, t=1, t=2, t=100, t=160, and t=256 of an autoregressive transformer (or a continuous diffusion model). In this example, as shown in time-step t=0, the autoregressive transformer will begin by accepting the sequence of prompt tokens 302 as input. Then, in time-step t=1, the autoregressive transformer will predict the first token 304 based on the sequence of prompt tokens 302. Next, in time-step t=2, the autoregressive transformer will predict the second token 306 based on the sequence of prompt tokens 302 and the predicted first token 304. Next, in time-step t=3 (not shown), the autoregressive transformer will predict a third token based on the sequence of prompt tokens 302 and the sequence of previously predicted tokens (first token 304 and second token 306). This process will repeat sequentially for each next token until the autoregressive transformer has predicted a full token sequence, as shown in time-step t=256.

The resulting final output token sequence may then be converted into an image in any suitable way. For example, in some aspects, the output token sequence may represent a vector-quantized image, and may thus be converted into a corresponding image by processing the sequence through a decoder of a vector-quantized autoencoder. In that regard, in some aspects, each token of the output vector may correspond to a different pixel of an image. Likewise, in some aspects, each token of the output vector may correspond to a group of pixels. For example, in some aspects, the final image may be a 256×256 pixel image, and each element of the 256-element output token sequence shown in FIG. 3 may correspond to a different 16×16 block of pixels. Similarly, in some aspects, the final image may be a 512×512 pixel image, and each element of the 256-element output token sequence shown in FIG. 3 may correspond to a different 32×32 block of pixels. Moreover, although the output token sequence is shown for simplicity in FIG. 3 as a grid or matrix, it will be understood that it may have any other suitable format. Thus, in some aspects of the technology, the output token sequence may be a flattened sequence representing a left-to-right, top-to-bottom scan of a grid overlaying the intended output image.

In some aspects of the technology, the autoregressive transformer may include a vector-quantized autoencoder capable of decoding the output token sequence into a corresponding image. Likewise, in some aspects of the technology, the output token sequence from the autoregressive transformer may be converted into a corresponding image by a decoder of a separate vector-quantized autoencoder.

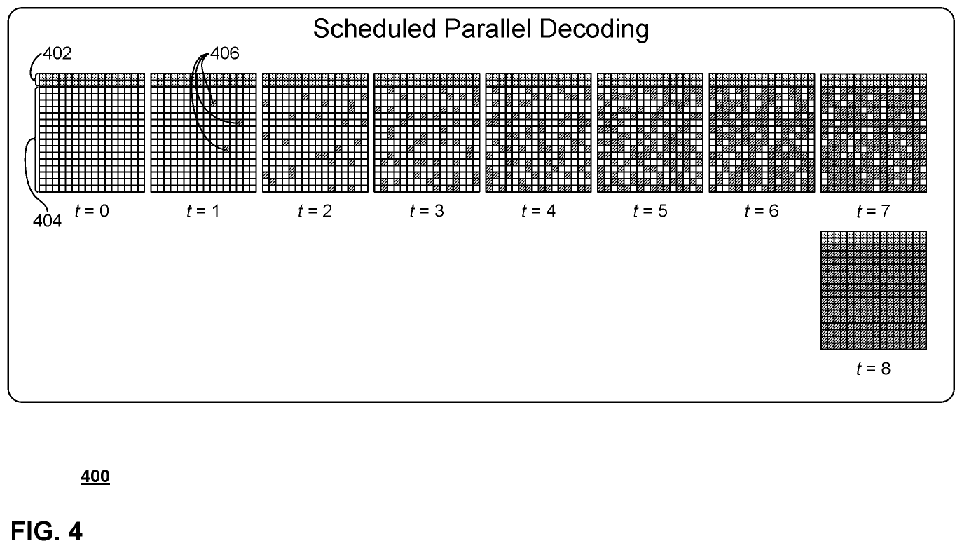

FIG. 4 is a flow chart illustrating an exemplary process flow 400 for generating an image using a non-autoregressive transformer and a sequence of prompt tokens, in accordance with aspects of the disclosure.

In that regard, FIG. 4 illustrates exemplary outputs representing time-steps t=0 to t=8 of a non-autoregressive transformer (or a discrete diffusion model). In this example, as shown in time-step t=0, the non-autoregressive transformer will begin by accepting the sequence of prompt tokens 402 and a fully-masked vector 404 as input. Then, in time-step t=1, the non-autoregressive transformer will predict values for each of the masked tokens in the vector 404 based on the sequence of prompt tokens 402, and will retain a predetermined number of those predicted values. The non-autoregressive transformer may determine which of the predicted values to retain based on any suitable criteria. For example, in some aspects, the non-autoregressive transformer may be configured to also generate a confidence score for each of the values it predicts, and may be configured to choose which values to retain based on which have the highest confidence scores. Likewise, in some aspects, a separate model (e.g., a learned token-critic) may be configured to process the output of the non-autoregressive transformer in each time-step and predict which token values are deemed the most realistic and should thus be retained into the next time-step. Notably, where a separate model is used, it may be configured to review all of the tokens of vector 404 for each time-step (those that were retained from the prior time-step and those that were predicted in the present time-step), thus allowing tokens retained in one time-step to be masked in the next time-step if other predicted tokens are deemed more realistic. This may minimize an “anchoring” effect in which tokens preserved from earlier time-steps end up overly influencing the final output, and thus may improve the variability and/or quality of the non-autoregressive transformer's final outputs.

In the example of FIG. 4, it is assumed that the values predicted for three tokens 406 will be retained in unmasked form as input to time-step t=2. Thus, in time-step t=2, the non-autoregressive transformer will predict values for each of the masked tokens in the vector 404 based on the sequence of prompt tokens 402 and the values of the three tokens 406 retained from step t=1, and will retain a predetermined number of those predicted values for use as input to time-step t=3. This process will repeat according to a suitable masking schedule until the final time-step (in this example, time-step t=8), where all of the predictions of the non-autoregressive transformer will be included in a final output vector. Here as well, the output token sequence in this final output vector may then be converted into an image in any suitable way. For example, in some aspects, the output token sequence may represent a vector-quantized image, and may thus be converted into a corresponding image by processing the sequence through a decoder of a vector-quantized autoencoder. In some aspects of the technology, the non-autoregressive transformer may include a vector-quantized autoencoder capable of decoding the output token sequence into a corresponding image. Likewise, in some aspects of the technology, the output token sequence from the non-autoregressive transformer may be converted into a corresponding image by a decoder of a separate vector-quantized autoencoder.

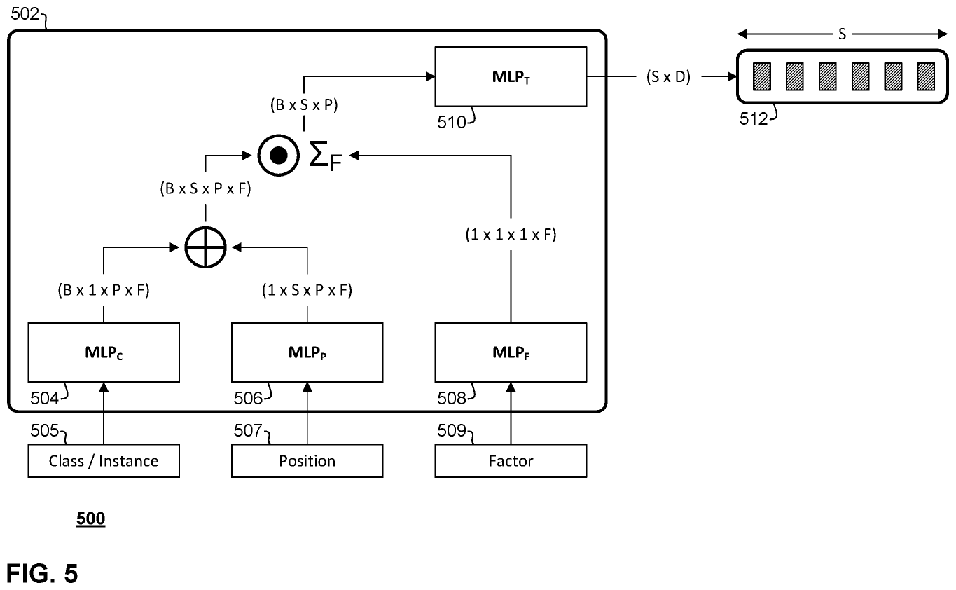

FIG. 5 is a flow chart illustrating an exemplary process flow 500 for generating a sequence of prompt tokens using a prompt token generator 502, in accordance with aspects of the disclosure.

In the example of FIG. 5, it is assumed that the prompt token generator 502 will include four separate multi-layer perceptrons MLP_{C} (504), MLP_{P} (506), MLP_{F} (508), and MLP_{T} (510). In this case, the first multi-layer perceptron MLP_{C} (504) is shown accepting information regarding a given class identifier and/or instance identifier 505 for each training example. It is assumed in FIG. 5 that there will be a batch of training examples. The output of MLP_{C} (504) is thus shown being a vector of dimension B×1×P×F, where B represents the number of training examples in the batch, P is a designated hidden dimension of the prompt token generator 502, and F is a factor value (509) which may be set to any value greater than or equal to 1 in order to effectively increase the number of parameters without requiring all of those parameters to be learnable. For example, in some aspects, a value of 1 may be used for non-autoregressive transformers (e.g., similar to those shown in FIG. 4), while a larger value (e.g., 16) may be used in autoregressive transformers (e.g., similar to those shown in FIG. 3).

In this case, the second multi-layer perceptron MLP_{P} (506) is shown accepting a position vector 507, in which each element corresponds to the position of a different token in the intended final output prompt token sequence S. The output of MLP_{P} (506) is thus shown being a vector of dimension 1×S×P×F, where S represents the number of tokens in the intended final output prompt token sequence.

The outputs of MLP_{C} (504) and MLP_{P} (506) are then combined as shown in FIG. 5 in order to generate a vector of dimension B×S×P×F. This may be done in any suitable way. For example, in some aspects, the output of MLP_{C} (504) may be replicated B times in the first dimension (thus generating a replicated vector of dimension B×S×P×F) and the output of MLP_{P} (506) may be replicated S times in the second dimension (thus generating another replicated vector of dimension B×S×P×F), and those two replicated vectors may then be element-wise summed (thus generating a summed vector of dimension B×S×P×F).

Further, in the example of FIG. 5, the third multi-layer perceptron MLP_{F} (508) is shown accepting a predetermined factor value 509. The output of MLP_{F} is thus shown being a vector of dimension 1×1×1×F, where F represents the factor value 509. This vector may then be combined in any suitable way with the summed vector that results from combining the replicated outputs of MLP_{C} (504) and MLP_{P} (506). For example, as shown in FIG. 5, the summed vector that results from combining the replicated outputs of MLP_{C} (504) and MLP_{P} (506) may be element-wise multiplied by the output of MLP_{F} (508), and then further summed in the F dimension, thus resulting in an output vector having a dimension of B×S×P.

The resulting B×S×P dimension vector may then be fed into the fourth multi-layer perceptron MLP_{T} (510) to produce a final sequence of prompt tokens 512. In this case, the final sequence of prompt tokens 512 is assumed to have a length of S tokens, with each token having a dimension of D. Thus, in some aspects of the technology, the final sequence of prompt tokens 512 may be represented as a vector of dimension S×D.

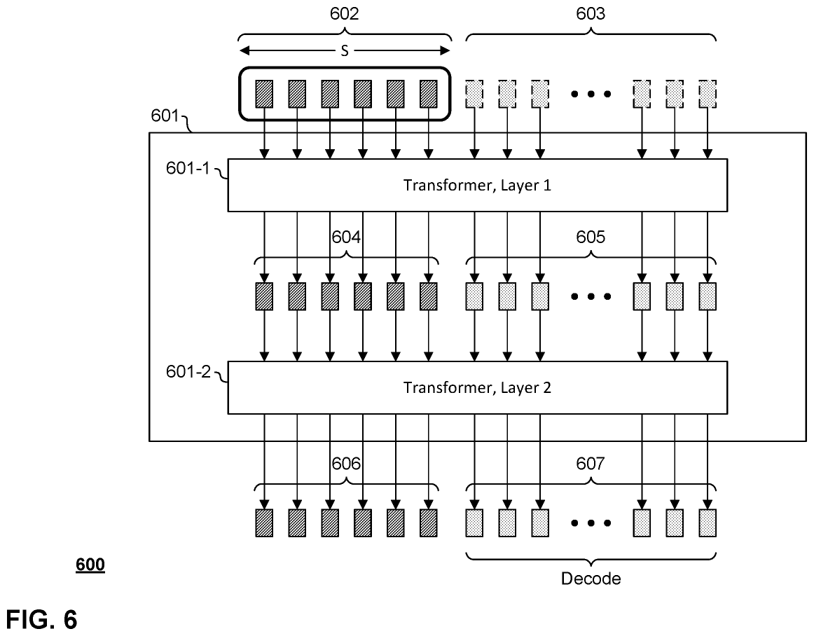

FIG. 6 is a flow chart illustrating an exemplary process flow 600 for generating an output token sequence based on a sequence of prompt tokens using a pretrained generative image transformer 601, in accordance with aspects of the disclosure.

The pretrained generative image transformer 601 may be any suitable type of transformer, such as an autoregressive transformer or continuous diffusion model (e.g., configured as discussed above with respect to FIG. 3), a non-autoregressive transformer or discrete diffusion model (e.g., configured as discussed above with respect to FIG. 4), etc. Although the pretrained generative image transformer 601 may have any suitable number of layers and parameters, in the example of FIG. 6, it is assumed for simplicity that the pretrained generative image transformer 601 will have two layers 601-1, 601-2. As such, the sequence of prompt tokens 602 (e.g., the final sequence of prompt tokens 512 output by the prompt token generator 502 of FIG. 5) is appended to an empty or fully-masked vector 603 that includes an element representing every token of the intended final output token sequence. The first layer 601-1 of the pretrained generative image transformer 601 will then produce an intermediate vector. In this case, it is assumed that first layer 601-1 of the generative image transformer 601 is configured to generate an intermediate vector of the same dimension as its input, which will thus include a sequence of tokens 604 of length S based on the initial sequence of S prompt tokens 602, as well as a set of tokens 605 based on the initial values in vector 603. The intermediate vector will then be passed to the second layer 601-2 of the pretrained generative image transformer 601, which will produce a final vector. Here as well, it is assumed that second layer 601-2 of the generative image transformer 601 is configured to generate a final vector of the same dimension as its input (the intermediate vector), which will thus include a sequence of tokens 606 of length S based on the intermediate sequence of tokens 604, as well as a set of tokens 607 based on the intermediate set of tokens 605. In this example, it is assumed that sequence of tokens 606 will be discarded, resulting in a final output token sequence 607 that may then be decoded in order to generate a corresponding image. Here as well, as discussed above with respect to FIGS. 3 and 4, this may be done in any suitable way, such as by processing the final output token sequence 607 through a decoder of a vector-quantized autoencoder.

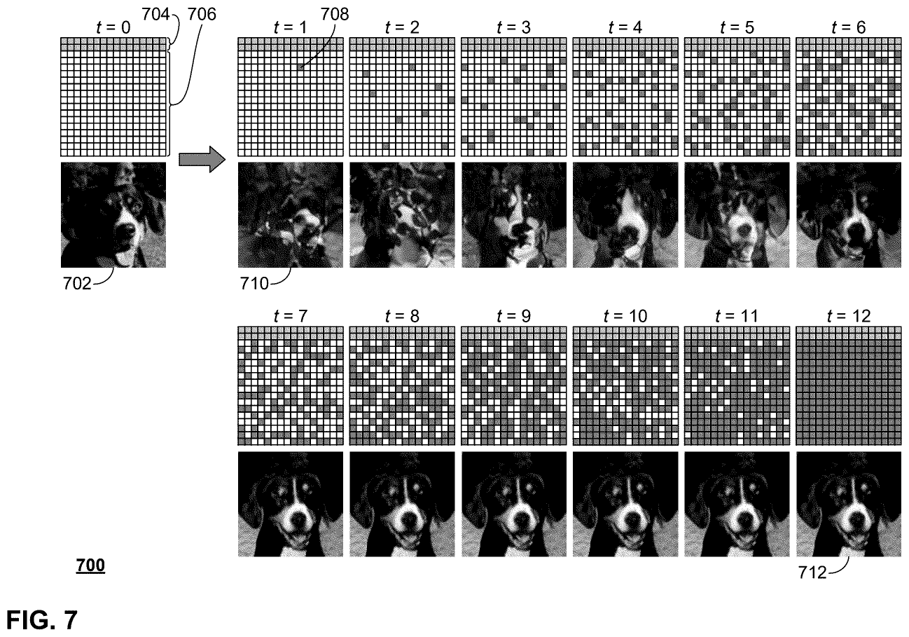

FIG. 7 is a diagram 700 illustrating exemplary images generated by a pretrained generative image transformer based on a single instance prompt, in accordance with aspects of the disclosure.

In that regard, the example of FIG. 7 assumes that a prompt token generator (not shown) has been trained on a set of training examples of which image 702 is one instance. The exemplary diagram 700 illustrates that the prompt token generator (e.g., prompt token generator 502 of FIG. 5) will produce a prompt token sequence 704 based at least on an instance identifier of image 702 (e.g., according to the process flow 500 of FIG. 5). In this example, the prompt token sequence 704 is used as input to a pretrained non-autoregressive generative image transformer or discrete diffusion model (e.g., configured as discussed above with respect to FIG. 4) in every time-step. Thus, the prompt token sequence 704 is shown being appended first to an empty or fully-masked vector 706 that includes an element representing every token of the intended output token sequence. Then, in the same way described above with respect to process flow 400 of FIG. 4, the prompt token sequence 704 and vector 706 will be fed to the pretrained non-autoregressive generative image transformer, which will predict values for each of the tokens in the vector 706 based on the sequence of prompt tokens 704, and will retain a predetermined number of those predicted values. In this example, it is assumed that the value predicted for one token 708 is retained from the predictions of time-step t=1. Then, in time-step t=2, the non-autoregressive transformer will predict values for each of the masked tokens in the vector 706 based on the sequence of prompt tokens 704 and the value of the one token 708 retained from step t=1, and will retain a predetermined number of those predicted values (shown again with shading). As above, this process will repeat according to a suitable masking schedule until the final time-step (in this example, time-step t=12), where all of the predictions of the non-autoregressive transformer will be included in a final output vector which includes a final output token sequence.

Here as well, the output token sequences generated in any or all of the time-steps may be converted into corresponding images, and this may be done in any suitable way as described above with respect to FIG. 4. For example, in some aspects, the output token sequence for each time-step may represent a vector-quantized image, and may thus be converted into a corresponding image by processing the sequence through a decoder of a vector-quantized autoencoder. In some aspects of the technology, the non-autoregressive transformer or discrete diffusion model may include a vector-quantized autoencoder capable of decoding the output token sequence into a corresponding image. Likewise, in some aspects of the technology, the output token sequence from the non-autoregressive transformer may be converted into a corresponding image by a decoder of a separate vector-quantized autoencoder.

To illustrate how a non-autoregressive transformer's or discrete diffusion model's outputs may evolve over each time-step, FIG. 7 shows an exemplary image corresponding to the output of each time-step (positioned below the grid representing vector 706 for that time-step). Thus, the generative image transformer's predictions in the first time-step t=1 are shown as image 710, and the transformer's predictions in the final time-step t=12 are shown as image 712.

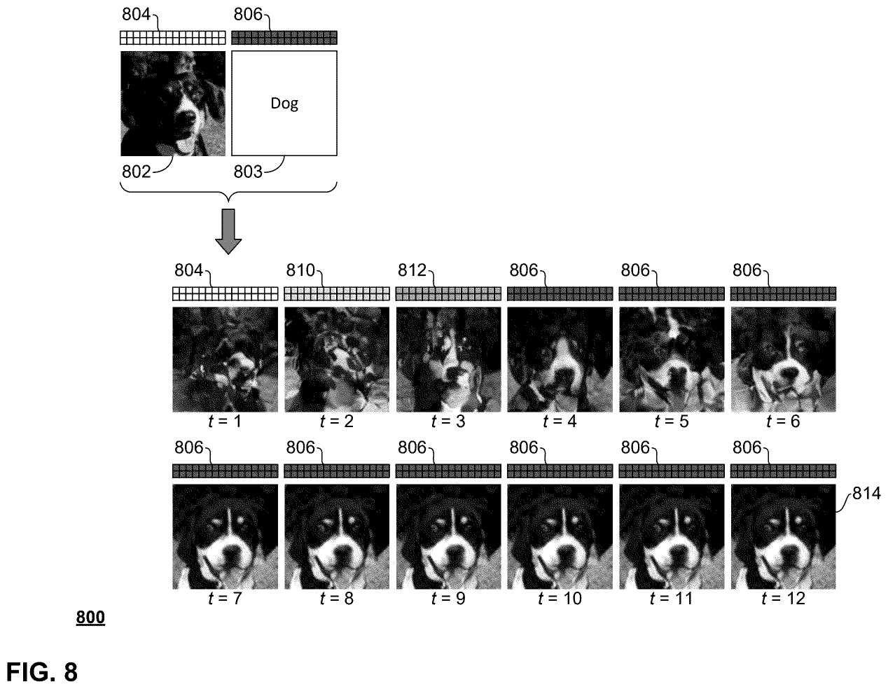

FIG. 8 is a diagram 800 illustrating exemplary images generated by a pretrained generative image transformer based on a set of prompts interpolated between a set of prompts for a single instance and a set of prompts for a class, in accordance with aspects of the disclosure.

In that regard, the example of FIG. 8 assumes that a prompt token generator (not shown) has been trained on a set of training examples including two or more images with a class identifier of “Dog,” of which image 802 is one instance. The exemplary diagram 800 illustrates that the prompt token generator (e.g., prompt token generator 502 of FIG. 5) will produce a first prompt token sequence 804 based at least on an instance identifier of image 802 (e.g., according to the process flow 500 of FIG. 5), and a second prompt token sequence 806 based at least on a class identifier 803 of “Dog” (e.g., also according to the process flow 500 of FIG. 5). The first and second prompt token sequences 804 and 806 will then be used to generate a set of prompt token sequences (804, 810, 812, 806), which may be used as input to a pretrained non-autoregressive generative image transformer or discrete diffusion model (e.g., configured as discussed above with respect to FIG. 4) in successive time-steps according to a suitable schedule. This set of prompt token sequences may be generated in any suitable way. For example, in some instances, a processing system may interpolate between the first prompt token sequence 804 and second prompt token sequence 806 in order to generate one or more intermediate prompt token sequences (e.g., prompt token sequences 810, 812).

In this case, the first prompt token sequence 804 is shown being used in the first time-step, followed by a first intermediate prompt token sequence 810 in the second time-step, followed by a second intermediate prompt token sequence 812 in the third time-step, followed by the second prompt token sequence 806 in all time-steps thereafter (fourth time-step through the twelfth time-step). As will be appreciated, any suitable number of intermediate prompt token sequences may be generated and used, and each prompt token sequence may be used in one or more time-steps according to any suitable schedule.

Here as well, to illustrate how a non-autoregressive transformer's or discrete diffusion model's outputs may evolve over each time-step when such a set of different prompt token sequences is used. FIG. 8 shows an exemplary image corresponding to the output of each time-step (positioned below the grid representing the prompt token sequence for that time-step). As can be seen, by interpolating between a first prompt token sequence 804 for a given instance (e.g., image 802 of a particular dog) and a second prompt token sequence 806 for the class 803 of that given instance (e.g., “Dog”), it is possible to generate a set of prompt token sequences (804, 810, 812, 806) that can be used to influence the pretrained non-autoregressive generative image transformer or discrete diffusion model to generate a final output token sequence which, when converted to a final image 814, shows another image in that class that is similar to that of the original instance. In this case, the final image 814 shows a dog with the same coloring as that shown in image 802, but in a slightly different posture and with a slightly different shape of face.

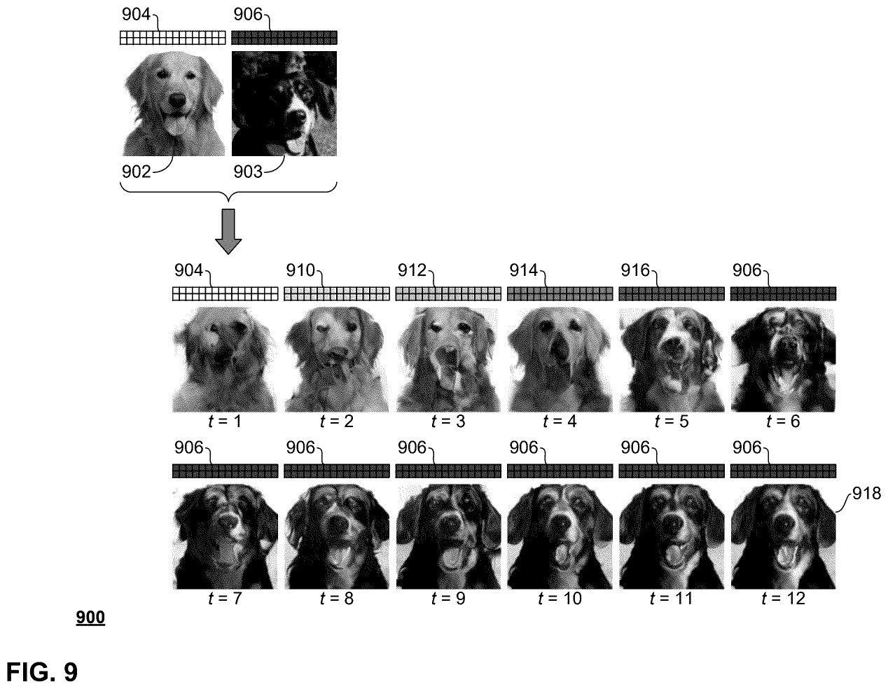

FIG. 9 is a diagram 900 illustrating exemplary images generated by a pretrained generative image transformer based on a set of prompts interpolated between sets of prompts for two different instances, in accordance with aspects of the disclosure.

In that regard, the example of FIG. 9 assumes that a prompt token generator (not shown) has been trained on a set of training examples, of which images 902 and 903 are two instances. The exemplary diagram 900 illustrates that the prompt token generator (e.g., prompt token generator 502 of FIG. 5) will produce a first prompt token sequence 904 based at least on an instance identifier of image 902 (e.g., according to the process flow 500 of FIG. 5), and a second prompt token sequence 906 based at least on an instance identifier of image 903 (e.g., also according to the process flow 500 of FIG. 5). Here as well, the first and second prompt token sequences 904 and 906 will then be used to generate a set of prompt token sequences (904, 910, 912, 914, 916, 906), which may be used as input to a pretrained non-autoregressive generative image transformer or discrete diffusion model (e.g., configured as discussed above with respect to FIG. 4) in successive time-steps according to a suitable schedule. This set of prompt token sequences may be generated in any suitable way. For example, in some instances, a processing system may interpolate between the first prompt token sequence 904 and second prompt token sequence 906 in order to generate one or more intermediate prompt token sequences (e.g., prompt token sequences 910, 912, 914, and 916).

In this case, the first prompt token sequence 904 is shown being used in the first time-step, followed by a first intermediate prompt token sequence 910 in the second time-step, followed by a second intermediate prompt token sequence 912 in the third time-step, followed by a third intermediate prompt token sequence 412 in the fourth time-step, followed by a fourth intermediate prompt token sequence 916 in the fifth time-step, followed by the second prompt token sequence 906 in all time-steps thereafter (sixth time-step through the twelfth time-step). As will be appreciated, any suitable number of intermediate prompt token sequences may be generated and used, and each prompt token sequence may be used in one or more time-steps according to any suitable schedule.

Here as well, to illustrate how a non-autoregressive transformer's or discrete diffusion model's outputs may evolve over each time-step when such a set of different prompt token sequences is used, FIG. 9 shows an exemplary image corresponding to the output of each time-step (positioned below the grid representing the prompt token sequence for that time-step). As can be seen, by interpolating between a first prompt token sequence 904 for a given first instance (e.g., image 902 of a first dog) and a second prompt token sequence 906 for a given second instance (e.g., image 903 of a second dog), it is possible to generate a set of prompt token sequences (904, 910, 912, 914, 916, 906) that can be used to influence the pretrained non-autoregressive generative image transformer or discrete diffusion model to generate a final output token sequence which, when converted to a final image 918, blends the visual characteristics of those two given instances. In this case, the final image 918 shows a dog with the same coloring as that shown in image 903, but with a posture and face-shape similar to that of image 902.

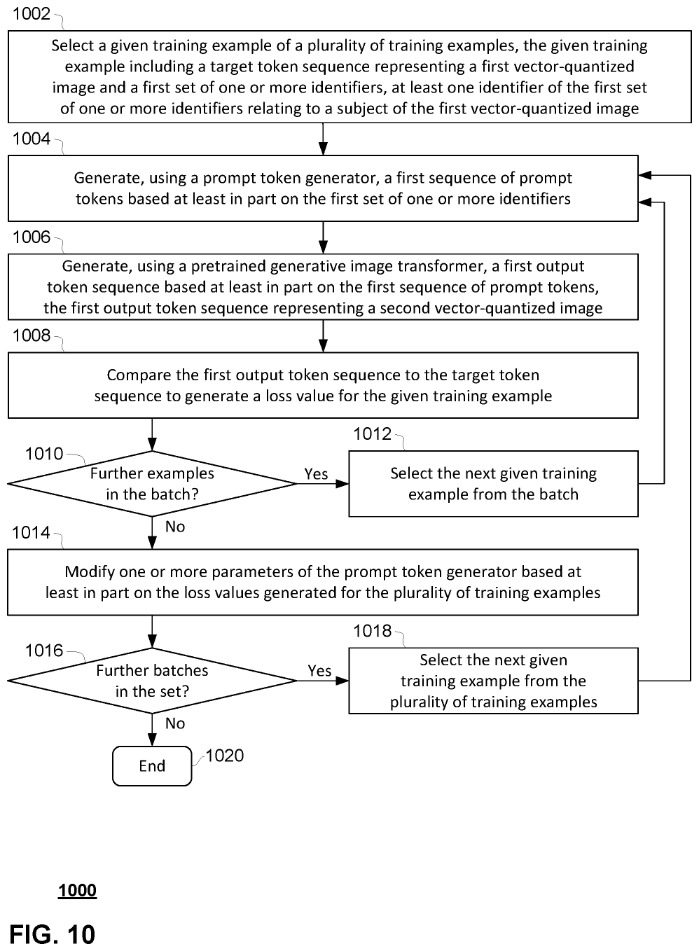

FIG. 10 depicts an exemplary method 1000 for training a prompt token generator, in accordance with aspects of the disclosure. In that regard, method 1000 may be used to train the prompt token generator 502 of FIG. 5.

In step 1002, a processing system (e.g., processing system 102 of FIG. 1 or 2) selects a given training example from a plurality of training examples, the given training example including a target token sequence representing a first vector-quantized image and a first set of one or more identifiers, at least one identifier of the first set of one or more identifiers relating to a subject of the first vector-quantized image.

The target token sequence may represent a first vector-quantized image in any suitable way, including in the same ways described above with respect to FIGS. 3, 4, and 7-9. Thus, for example, in some aspects, each token of the target token sequence may correspond to a different pixel of an image. Likewise, in some aspects, each token of the target token sequence may correspond to a group of pixels. For example, in some aspects, for a 256×256 pixel image, the target token sequence may be a 256-element vector, in which each element corresponds to a different 16×16 block of pixels. Similarly, in some aspects, for a 512×512 pixel image, the target token sequence may be a 256-element vector, in which each element corresponds to a different 32×32 block of pixels.

The first set of one or more identifiers may include any suitable types of identifiers that relate to the subject of the first vector-quantized image that the prompt token generator may be configured to accept. For example, in some aspects of the technology, the first set of one or more identifiers may include a class identifier and/or an instance identifier as described above with respect to class identifier and/or instance identifier 505 of FIG. 5. In addition, in some aspects, the first set of one or more identifiers may include additional identifiers that are not related to the subject of the first vector-quantized image, such as a position vector (e.g., as described above with respect to position identifier 507 of FIG. 5) and/or a predetermined factor value (e.g., as described above with respect to factor value 509 of FIG. 5).

In step 1004, the processing system uses a prompt token generator to generate a first sequence of prompt tokens based at least in part on the first set of one or more identifiers. The prompt token generator may be any suitable type of model configured to generate a sequence of prompt tokens based on a set of one or more identifiers, and may have any suitable number of parameters. For example, in some aspects of the technology, the prompt token generator may include one or more multi-layer perceptrons as described above with respect to the prompt token generator 502 of FIG. 5, for which the number of trainable parameters is P. (F. (C+S)+D). Likewise, the prompt token generator may also be configured to generate a first sequence of prompt tokens of any suitable length and with tokens of any suitable dimension. For example, in some aspects of the technology, the first sequence of prompt tokens may be a sequence of length S, with each token having a dimension of D, as described above with respect to the final sequence of prompt tokens 512 of FIG. 5. Each of P, F, C, S, and D may be set to any suitable value. For example, in some aspects of the technology, S may have a value of 128, P may have a value of 768, D may have a value of 768, C may have a value of 100, and the value of F may be an integer between 1 and 16 based on the type of transformer used (e.g., as described above with respect to factor value 509 of FIG. 5).

In step 1006, the processing system uses a pretrained generative image transformer to generate a first output token sequence based at least in part on the first sequence of prompt tokens, the first output token sequence representing a second vector-quantized image.

Here as well, the first output token sequence may represent a second vector-quantized image in any suitable way, including in the same ways described above (in step 1002) with respect to how the target token sequence may represent the first vector-quantized image.

The pretrained generative image transformer may be any suitable type of transformer, such as an autoregressive transformer or continuous diffusion model (e.g., configured as discussed above with respect to FIG. 3), a non-autoregressive transformer or discrete diffusion model (e.g., configured as discussed above with respect to FIG. 4), etc. The pretrained generative image transformer may have any suitable number of layers and parameters. For example, in some aspects of the technology, the pretrained generative image transformer may be an autoregressive transformer or continuous diffusion model trained on 256×256 pixel images, having 24 transformer layers and 306 million parameters. Likewise, in some aspects of the technology, the pretrained generative image transformer may be a non-autoregressive transformer or discrete diffusion model trained on 256×256 pixel images, having 24 transformer layers and 172 million parameters.

In step 1008, the processing system compares the first output token sequence to the target token sequence to generate a loss value for the given training example. The processing system may make this comparison and generate a loss value in any suitable way, using any suitable loss function(s). For example, in some aspects of the technology, the processing system may be configured to compare the first output token sequence to the target token sequence using a binary cross-entropy loss function to generate the loss value. Likewise, it will be appreciated that other types of classification loss may alternatively be used.

In step 1010, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 1012. In step 1012, the processing system will select the next given training example from the batch, and then repeat steps 1004-1010 for that newly selected training example. This process will then be repeated for each next given training example of the batch until the processing system determines, at step 1010, that there are no further training examples in the batch, and thus proceeds to step 1014 (as shown by the “no” arrow).

As shown in step 1014, after a loss value has been generated (in step 1008) for every given training example in the batch, the processing system modifies one or more parameters of the prompt token generator based at least in part on the generated loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the prompt token generator every time a loss value is generated. Further in that regard, the processing system may be configured to combine (e.g., add) the loss values generated for each given training example to generate a single aggregate loss value for the given training example, and to modify the one or more parameters based on that aggregate loss value. Likewise, where each “batch” includes two or more training examples, the processing system may be configured to combine the generated loss values into an aggregate loss value for the batch (e.g., by summing or averaging the multiple loss values), and modify the one or more parameters of the prompt token generator based on that aggregate loss value.

In step 1016, the processing system determines if there are further batches in the plurality of training examples. Where the plurality of training examples has not been broken up, and there is thus one single “batch” containing every training example in the plurality of training examples, the determination in step 1016 will automatically be “no,” and method 1000 will then end as shown in step 1020. However, where the plurality of training examples has been broken into two or more batches, the processing system will follow the “yes” arrow to step 1018 to select the next given training example from the plurality of training examples. This will then start another set of passes through steps 1004-1010 for each training example in the next batch and another modification of one or more parameters of the prompt token generator in step 1014. This process will continue until there are no further batches remaining, at which point the processing system will follow the “no” arrow to step 1020.

Although method 1000 is shown as ending at step 1020 once all training examples of the plurality of training examples have been used to tune the parameters of the prompt token generator, it will be understood that method 1000 may be repeated any suitable number of times using the same plurality of training examples until each of its predicted first output token sequences is sufficiently close to its respective target token sequence in each training example. In that regard, in some aspects of the technology, the processing system may be configured to repeat method 1000 for the plurality of training examples some predetermined number of times. Further, in some aspects, the processing system may be configured to aggregate all of the loss values generated during a given pass through method 1000, and determine whether to repeat method 1000 for the plurality of training examples based on that aggregate loss value. For example, in some aspects of the technology, the processing system may be configured to repeat method 1000 for the plurality of training examples if the aggregate loss value for the most recent pass through method 1000 was greater than some predetermined threshold. Likewise, in some aspects, the processing system may be configured to use gradient descent, and to thus repeat method 1000 for the plurality of training examples until the aggregate loss value on a given pass through method 1000 is equal to or greater than the aggregate loss value from the pass before it.

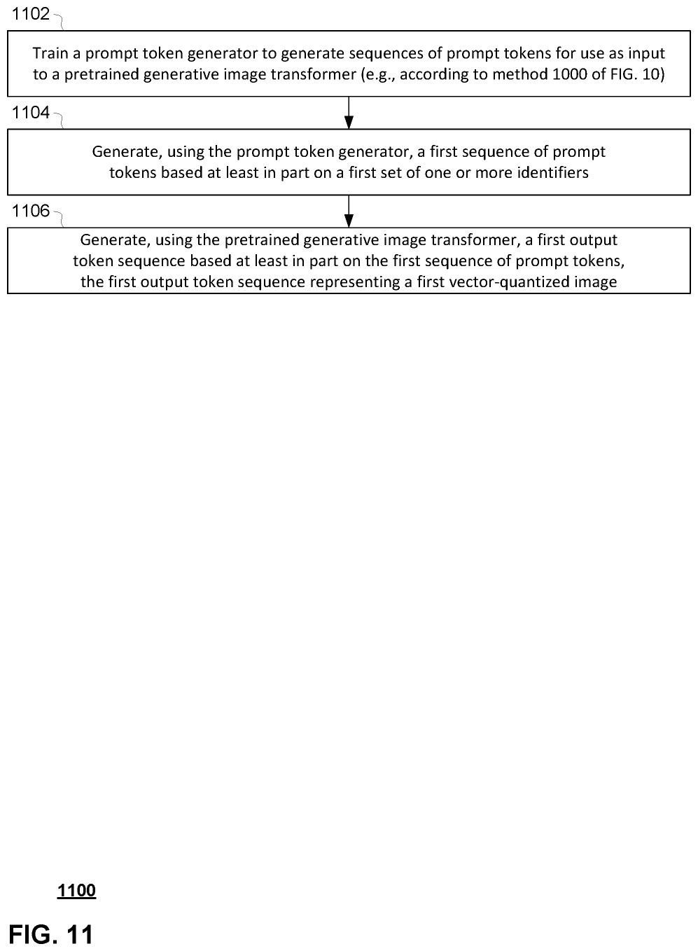

FIG. 11 depicts an exemplary method 1100 for using a trained prompt token generator to generate a sequence of prompt tokens and using a pretrained generative image transformer to generate an output token sequence based on the sequence of prompt tokens, in accordance with aspects of the disclosure.

In that regard, as shown in step 1102, it is assumed that a prompt token generator is trained to generate sequences of prompt tokens for use as input to a pretrained generative image transformer. This may be done in any suitable way. For example, in some aspects of the technology, a processing system (e.g., processing system 102 of FIG. 1 or 2) may train the prompt token generator according to method 1000 of FIG. 10.

Here as well, the prompt token generator may be any suitable type of model configured to generate a sequence of prompt tokens based on a set of one or more identifiers, and may have any suitable number of parameters. For example, in some aspects of the technology, the prompt token generator may include one or more multi-layer perceptrons as described above with respect to the prompt token generator 502 of FIG. 5, for which the number of trainable parameters is P·(F·(C+S)+D). Likewise, the prompt token generator may also be configured to generate sequences of prompt tokens of any suitable length and with tokens of any suitable dimension. For example, in some aspects of the technology, the generated sequences of prompt tokens may be sequences of length S, with each token having a dimension of D, as described above with respect to the final sequence of prompt tokens 512 of FIG. 5. Each of P, F, C, S, and D may be set to any suitable value. For example, in some aspects of the technology, S may have a value of 128, P may have a value of 768, D may have a value of 768, C may have a value of 100, and the value of F may be an integer between 1 and 16 based on the type of transformer used (e.g., as described above with respect to factor value 509 of FIG. 5).

In step 1104, a processing system (e.g., processing system 102 of FIG. 1 or 2) uses the prompt token generator to generate a first sequence of prompt tokens based at least in part on a first set of one or more identifiers.

Here as well, the first set of one or more identifiers may include any suitable types of identifiers that the prompt token generator may be configured to accept. For example, in some aspects of the technology, the first set of one or more identifiers may include a class identifier and/or an instance identifier as described above with respect to class identifier and/or instance identifier 505 of FIG. 5. In addition, in some aspects, the first set of one or more identifiers may include additional identifiers that are not related to the subject of the images on which the prompt token generator was trained, such as a position vector (e.g., as described above with respect to position identifier 507 of FIG. 5) and/or a predetermined factor value (e.g., as described above with respect to factor value 509 of FIG. 5).

In step 1106, the processing system uses the pretrained generative image transformer to generate a first output token sequence based at least in part on the first sequence of prompt tokens, the first output token sequence representing a first vector-quantized image.

Here as well, the pretrained generative image transformer may be any suitable type of transformer, such as an autoregressive transformer or continuous diffusion model (e.g., configured as discussed above with respect to FIG. 3), a non-autoregressive transformer or discrete diffusion model (e.g., configured as discussed above with respect to FIG. 4), etc. The pretrained generative image transformer may have any suitable number of layers and parameters. For example, in some aspects of the technology, the pretrained generative image transformer may be an autoregressive transformer or continuous diffusion model trained on 256×256 pixel images, having 24 transformer layers and 306 million parameters. Likewise, in some aspects of the technology, the pretrained generative image transformer may be a non-autoregressive transformer or discrete diffusion model trained on 256×256 pixel images, having 24 transformer layers and 172 million parameters.

In addition, the first output token sequence may represent a first vector-quantized image in any suitable way, including in the same ways described above with respect to FIGS. 3, 4, and 7-9. Thus, for example, in some aspects, each token of the first output token sequence may correspond to a different pixel of an image. Likewise, in some aspects, each token of the first output token sequence may correspond to a group of pixels. For example, in some aspects, for a 256×256 pixel image, the first output token sequence may be a 256-element vector, in which each element corresponds to a different 16×16 block of pixels. Similarly, in some aspects, for a 512×512 pixel image, the first output token sequence may be a 256-element vector, in which each element corresponds to a different 32×32 block of pixels.

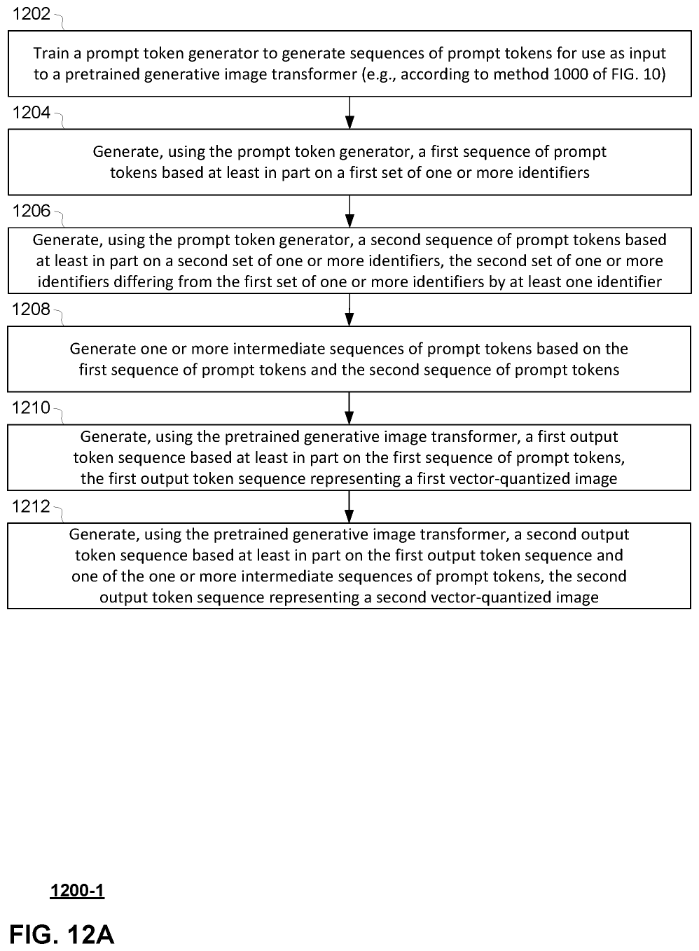

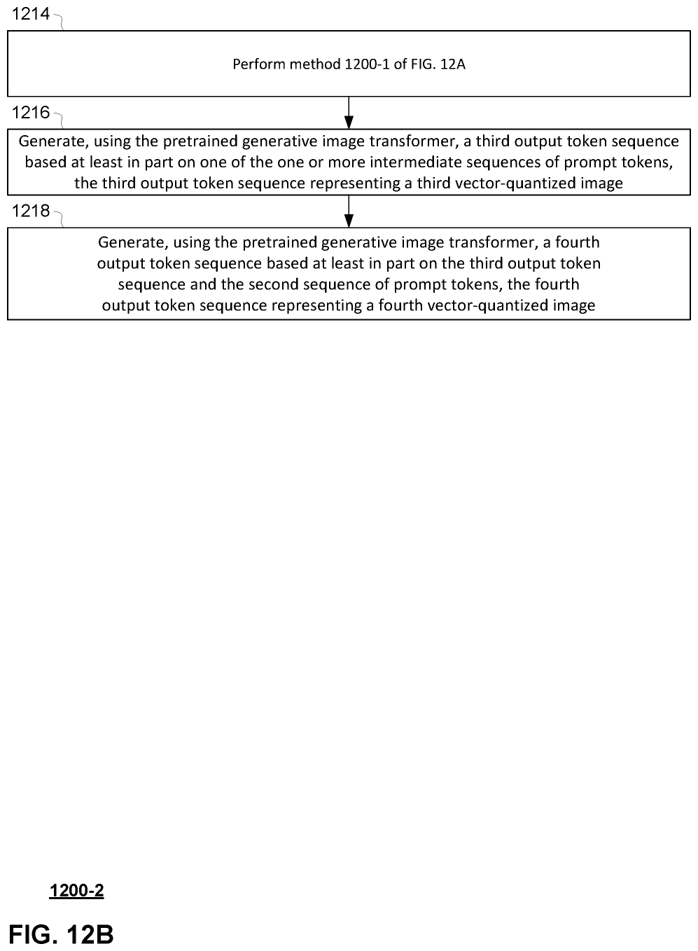

FIG. 12A depicts an exemplary method 1200-1 for using a trained prompt token generator to generate two sequences of prompt tokens, generating one or more intermediate sequences of prompt tokens based on the two sequences of prompt tokens generated by the token generator, and sequentially feeding two of the sequences of prompt tokens to a pretrained generative image transformer to generate two successive output token sequences, in accordance with aspects of the disclosure.

In that regard, as shown in step 1202, it is assumed that a prompt token generator is trained to generate sequences of prompt tokens for use as input to a pretrained generative image transformer. This may be done in any suitable way. For example, in some aspects of the technology, a processing system (e.g., processing system 102 of FIG. 1 or 2) may train the prompt token generator according to method 1000 of FIG. 10.

Here as well, the prompt token generator may be any suitable type of model configured to generate a sequence of prompt tokens based on a set of one or more identifiers, and may have any suitable number of parameters. For example, in some aspects of the technology, the prompt token generator may include one or more multi-layer perceptrons as described above with respect to the prompt token generator 502 of FIG. 5, for which the number of trainable parameters is P·(F·(C+S)+D). Likewise, the prompt token generator may also be configured to generate sequences of prompt tokens of any suitable length and with tokens of any suitable dimension. For example, in some aspects of the technology, the generated sequences of prompt tokens may be sequences of length S, with each token having a dimension of D, as described above with respect to the final sequence of prompt tokens 512 of FIG. 5. Each of P, F, C, S, and D may be set to any suitable value. For example, in some aspects of the technology, S may have a value of 128, P may have a value of 768, D may have a value of 768, C may have a value of 100, and the value of F may be a value between 1 and 16 based on the type of transformer used (e.g., as described above with respect to factor value 509 of FIG. 5).

In step 1204, a processing system (e.g., processing system 102 of FIG. 1 or 2) uses the prompt token generator to generate a first sequence of prompt tokens based at least in part on a first set of one or more identifiers.

Here as well, the first set of one or more identifiers may include any suitable types of identifiers that the prompt token generator may be configured to accept. For example, in some aspects of the technology, the first set of one or more identifiers may include a class identifier and/or an instance identifier as described above with respect to class identifier and/or instance identifier 505 of FIG. 5. In addition, in some aspects, the first set of one or more identifiers may include additional identifiers that are not related to the subject of the images on which the prompt token generator was trained, such as a position vector (e.g., as described above with respect to position identifier 507 of FIG. 5) and/or a predetermined factor value (e.g., as described above with respect to factor value 509 of FIG. 5).

In step 1206, the processing system uses the prompt token generator to generate a second sequence of prompt tokens based at least in part on a second set of one or more identifiers, the second set of one or more identifiers differing from the first set of one or more identifiers by at least one identifier.

Here as well, the second set of one or more identifiers may include any suitable types of identifiers that the prompt token generator may be configured to accept, including any of the options described above in step 1204 with respect to the first set of one or more identifiers. In addition, the second set of one or more identifiers may differ from the first set of one or more identifiers in any suitable way. For example, the first set of one or more identifiers may include an instance identifier of a first image on which the prompt token generator was trained (e.g. the instance identifier of image 802 of FIG. 8), and the second set of one or more identifiers may include a class identifier associated with multiple images on which the prompt token generator was trained (e.g., the class identifier 803 of FIG. 8). Likewise, in another example, the first set of one or more identifiers may include an instance identifier of a first image on which the prompt token generator was trained (e.g. the instance identifier of image 902 of FIG. 9), and the second set of one or more identifiers may include an instance identifier of a second image on which the prompt token generator was trained (e.g., the instance identifier 903 of FIG. 9).

In step 1208, the processing system generates one or more intermediate sequences of prompt tokens based on the first sequence of prompt tokens and the second sequence of prompt tokens. The processing system may be configured to use the first sequence of prompt tokens and the second sequence of prompt tokens in any suitable way in order to generate these one or more intermediate sequences. For example, in some aspects of the technology, the processing system may interpolate between the first sequence of prompt tokens and the second sequence of prompt tokens to generate the one or more intermediate sequences, as described above with respect to the generation of intermediate prompt token sequences 810 and 812 of FIG. 8 and intermediate prompt token sequences 910, 912, 914, and 916 of FIG. 9.

In step 1210, the processing system uses the pretrained generative image transformer to generate a first output token sequence based at least in part on the first sequence of prompt tokens, the first output token sequence representing a first vector-quantized image.

For example, the processing system may use the pretrained generative image transformer to generate a first output token sequence based at least in part on the first sequence of prompt tokens in the same way that the first prompt token sequence 804 of FIG. 8 is used to generate an output token sequence representing an exemplary image in time-step t=1. Likewise, the processing system may use the pretrained generative image transformer to generate a first output token sequence based at least in part on the first sequence of prompt tokens in the same way that the first prompt token sequence 904 of FIG. 9 is used to generate an output token sequence representing an exemplary image in time-step t=1.

Here as well, the pretrained generative image transformer may be any suitable type of transformer, such as an autoregressive transformer or continuous diffusion model (e.g., configured as discussed above with respect to FIG. 3), a non-autoregressive transformer or discrete diffusion model (e.g., configured as discussed above with respect to FIG. 4), etc. The pretrained generative image transformer may have any suitable number of layers and parameters. For example, in some aspects of the technology, the pretrained generative image transformer may be an autoregressive transformer or continuous diffusion model trained on 256×256 pixel images, having 24 transformer layers and 306 million parameters. Likewise, in some aspects of the technology, the pretrained generative image transformer may be a non-autoregressive transformer or discrete diffusion model trained on 256×256 pixel images, having 24 transformer layers and 172 million parameters.

In addition, the first output token sequence may represent a first vector-quantized image in any suitable way, including in the same ways described above with respect to FIGS. 3, 4, and 7-9. Thus, for example, in some aspects, each token of the first output token sequence may correspond to a different pixel of an image. Likewise, in some aspects, each token of the first output token sequence may correspond to a group of pixels. For example, in some aspects, for a 256×256 pixel image, the first output token sequence may be a 256-element vector, in which each element corresponds to a different 16×16 block of pixels. Similarly, in some aspects, for a 512×512 pixel image, the first output token sequence may be a 256-element vector, in which each element corresponds to a different 32×32 block of pixels.

In step 1212, the processing system uses the pretrained generative image transformer to generate a second output token sequence based at least in part on the first output token sequence and one of the one or more intermediate sequences of prompt tokens, the second output token sequence representing a second vector-quantized image.

For example, the processing system may use the pretrained generative image transformer to generate a second output token sequence based at least in part on the first output token sequence and one of the intermediate sequences of prompt tokens in the same way that some or all of the output token sequence from time-step t=1 of FIG. 8 may be used together with the intermediate prompt token sequence 810 to generate an output token sequence representing a second exemplary image in time-step t=2. Likewise, the processing system may use the pretrained generative image transformer to generate a second output token sequence based at least in part on the first output token sequence and one of the intermediate sequences of prompt tokens in the same way that some or all of the output token sequence from time-step t=1 of FIG. 9 may be used together with the intermediate prompt token sequence 910 to generate an output token sequence representing a second exemplary image in time-step t=2. In all cases, the pretrained generative image transformer may generate the second output token sequence based on the entire first output token sequence, or on a portion of the first output token sequence. For example, in some aspects of the technology, the pretrained generative image transformer may generate the second output token sequence based on a masked version of the first output token sequence, as described above with respect to FIGS. 4 and 7.

Here as well, the second output token sequence may represent a second vector-quantized image in any suitable way, including any of the options described above in step 1210 with respect to how the first vector-quantized image may represent the first vector-quantized image.

FIG. 12B depicts an exemplary method 1200-2 building from the exemplary method 1200-1 of FIG. 12A, for sequentially feeding another two of the generated sequences of prompt tokens to the pretrained generative image transformer to generate two additional successive output token sequences, in accordance with aspects of the disclosure.

In that regard, as shown in step 1214, it is assumed that each of steps 1202-1212 of method 1200-1 of FIG. 12A will have been performed in the manner described above.

Then, in step 1216, the processing system uses the pretrained generative image transformer to generate a third output token sequence based at least in part on one of the one or more intermediate sequences of prompt tokens (generated in step 1208 of FIG. 12A), the third output token sequence representing a third vector-quantized image. As will be appreciated, the pretrained generative image transformer may generate this third output token sequence based on more than just the selected intermediate sequence of prompt tokens. Thus, for example, the pretrained generative image transformer may generate the third output token sequence based on the selected one of the one or more intermediate sequences of prompt tokens as well as some or all of an output token sequence from a prior time-step (e.g., a masked version of the second output token sequence, as described above with respect to FIGS. 4 and 7).

For example, the processing system may use the pretrained generative image transformer to generate a third output token sequence based at least in part on one of the intermediate sequences of prompt tokens in the same way that one of the intermediate prompt token sequences 810 or 812 of FIG. 8 may be used (together with a masked version of the output token sequence from the prior time-step) to generate an output token sequence representing an exemplary image in time-step t=2 or t=3. Likewise, the processing system may use the pretrained generative image transformer to generate a third output token sequence based at least in part on one of the intermediate sequences of prompt tokens in the same way that one of the intermediate prompt token sequences 910, 912, 914, or 916 of FIG. 9 may be used (together with a masked version of the output token sequence from the prior time-step) to generate an output token sequence representing an exemplary image in time-step t=2, 1=3, t=4, or t=5.

Here as well, the third output token sequence may represent a third vector-quantized image in any suitable way, including any of the options described above in step 1210 with respect to how the first vector-quantized image may represent the first vector-quantized image.

In step 1218, the processing system uses the pretrained generative image transformer to generate a fourth output token sequence based at least in part on the third output token sequence and the second sequence of prompt tokens, the fourth output token sequence representing a fourth vector-quantized image.

For example, the processing system may use the pretrained generative image transformer to generate a fourth output token sequence based at least in part on the third output token sequence and the second sequence of prompt tokens in the same way that some or all of the output token sequence from time-step t=3 of FIG. 8 may be used together with the second prompt token sequence 806 to generate an output token sequence representing an exemplary image in time-step t=4. Likewise, the processing system may use the pretrained generative image transformer to generate a fourth output token sequence based at least in part on the third output token sequence and the second sequence of prompt tokens in the same way that some or all of the output token sequence from time-step t=5 of FIG. 9 may be used together with the second prompt token sequence 906 to generate an output token sequence representing an exemplary image in time-step t=6. Here as well, in all cases, the pretrained generative image transformer may generate the fourth output token sequence based on the entire third output token sequence, or on a portion of the third output token sequence. For example, in some aspects of the technology, the pretrained generative image transformer may generate the fourth output token sequence based on a masked version of the third output token sequence, as described above with respect to FIGS. 4 and 7.

Here as well, the fourth output token sequence may represent a fourth vector-quantized image in any suitable way, including any of the options described above in step 1210 with respect to how the first vector-quantized image may represent the first vector-quantized image.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method, comprising:
for each given training example of a plurality of training examples, the given training example including a target token sequence representing a first vector-quantized image and a first set of one or more identifiers, at least one identifier of the first set of one or more identifiers relating to a subject of the first vector-quantized image:
generating, using a prompt token generator, a first sequence of prompt tokens based at least in part on the first set of one or more identifiers;
generating, using a pretrained generative image transformer, a first output token sequence based at least in part on the first sequence of prompt tokens, the first output token sequence representing a second vector-quantized image; and
comparing, using one or more processors of a processing system, the first output token sequence to the target token sequence to generate a loss value for the given training example; and
modifying, using the one or more processors, one or more parameters of the prompt token generator based at least in part on the loss values generated for the plurality of training examples.

2. The method of claim 1, wherein the prompt token generator comprises two or more multi-layer perceptrons, and
wherein modifying the one or more parameters of the prompt token generator comprises modifying one or more parameters of each of the two or more multi-layer perceptrons.

3. The method of claim 1, wherein the first set of one or more identifiers of the given training example comprises a class identifier relating to the subject of the first vector-quantized image.

4. The method of claim 1, wherein the first set of one or more identifiers of the given training example comprises an instance identifier relating to the first vector-quantized image.

5. The method of claim 1, further comprising:
generating, using the prompt token generator, a second sequence of prompt tokens based at least in part on a second set of one or more identifiers; and
generating, using the pretrained generative image transformer, a second output token sequence based at least in part on the second sequence of prompt tokens, the second output token sequence representing a third vector-quantized image.

6. The method of claim 1, further comprising:
generating, using the prompt token generator, a second sequence of prompt tokens based at least in part on a second set of one or more identifiers;
generating, using the prompt token generator, a third sequence of prompt tokens based at least in part on a third set of one or more identifiers, the third set of one or more identifiers differing from the second set of one or more identifiers by at least one identifier;
generating, using the one or more processors, one or more intermediate sequences of prompt tokens based on the second sequence of prompt tokens and the third sequence of prompt tokens;
generating, using the pretrained generative image transformer, a second output token sequence based at least in part on the second sequence of prompt tokens, the second output token sequence representing a third vector-quantized image; and
generating, using the pretrained generative image transformer, a third output token sequence based at least in part on the second output token sequence and one of the one or more intermediate sequences of prompt tokens, the third output token sequence representing a fourth vector-quantized image.

7. The method of claim 6, further comprising:
generating, using the pretrained generative image transformer, a fourth output token sequence based at least in part on one of the one or more intermediate sequences of prompt tokens, the fourth output token sequence representing a fifth vector-quantized image; and
generating, using the pretrained generative image transformer, a fifth output token sequence based at least in part on the fourth output token sequence and the third sequence of prompt tokens, the fifth output token sequence representing a sixth vector-quantized image.

8. The method of claim 7, further comprising:
generating an output image based on the fifth output token sequence.

9. A processing system comprising:
a memory storing a pretrained generative image transformer and a prompt token generator; and
one or more processors coupled to the memory and configured to train the prompt token generator according to a training method comprising:
for each given training example of a plurality of training examples, the given training example including a target token sequence representing a first vector-quantized image and a first set of one or more identifiers, at least one identifier of the first set of one or more identifiers relating to a subject of the first vector-quantized image:
generating, using the prompt token generator, a first sequence of prompt tokens based at least in part on the first set of one or more identifiers;
generating, using the pretrained generative image transformer, a first output token sequence based at least in part on the first sequence of prompt tokens, the first output token sequence representing a second vector-quantized image; and
comparing the first output token sequence to the target token sequence to generate a loss value for the given training example; and
modifying one or more parameters of the prompt token generator based at least in part on the loss values generated for the plurality of training examples.

10. The system of claim 9, wherein the prompt token generator comprises a multi-layer perceptron.

11. The system of claim 9, wherein the prompt token generator comprises two or more multi-layer perceptrons.

12. The system of claim 11, wherein the one or more processors being configured to modify the one or more parameters of the prompt token generator comprises modifying one or more parameters of each of the two or more multi-layer perceptrons.

13. The system of claim 9, wherein the one or more processors are further configured to:
generate, using the prompt token generator, a second sequence of prompt tokens based at least in part on a second set of one or more identifiers; and
generate, using the pretrained generative image transformer, a second output token sequence based at least in part on the second sequence of prompt tokens, the second output token sequence representing a third vector-quantized image.

14. The system of claim 9, wherein the one or more processors are further configured to:
generate, using the prompt token generator, a second sequence of prompt tokens based at least in part on a second set of one or more identifiers;
generate, using the prompt token generator, a third sequence of prompt tokens based at least in part on a third set of one or more identifiers, the third set of one or more identifiers differing from the second set of one or more identifiers by at least one identifier;
generate one or more intermediate sequences of prompt tokens based on the second sequence of prompt tokens and the third sequence of prompt tokens;
generate, using the pretrained generative image transformer, a second output token sequence based at least in part on the second sequence of prompt tokens, the second output token sequence representing a third vector-quantized image; and
generate, using the pretrained generative image transformer, a third output token sequence based at least in part on the second output token sequence and one of the one or more intermediate sequences of prompt tokens, the third output token sequence representing a fourth vector-quantized image.

15. The system of claim 14, wherein the one or more processors are further configured to:
generate, using the pretrained generative image transformer, a fourth output token sequence based at least in part on one of the one or more intermediate sequences of prompt tokens, the fourth output token sequence representing a fifth vector-quantized image; and
generate, using the pretrained generative image transformer, a fifth output token sequence based at least in part on the fourth output token sequence and the third sequence of prompt tokens, the fifth output token sequence representing a sixth vector-quantized image.

16. The system of claim 15, wherein the one or more processors are further configured to:
generate an output image based on the fifth output token sequence.

17. The system of claim 16, wherein the one or more processors are configured to generate the output image using a decoder of the pretrained generative image transformer.

18. The system of claim 9, wherein the pretrained generative image transformer is an autoregressive image transformer.

19. The system of claim 9, wherein the pretrained generative image transformer is a non-autoregressive image transformer.

20. A non-transitory computer program product comprising computer readable instructions that, when executed by a processing system, cause the processing system to perform the method of claims 1 to 8.
